(19) United States
(12) Patent Application Publication
(10) Pub. No.: US 2016/0378812 A1
(43) Pub. Date: Dec. 29, 2016

(54) REDUCTION OF BIND BREAKS

(71) Applicant: International Business Machines Corporation, Armonk, NY (US)

(72) Inventors: Harris M. Morgenstern, Wappingers Falls, NY (US); Steven M. Partlow, Beacon, NY (US); Thomas F. Rankin, Tillson, NY (US); Peter J. Relson, Ulster Park, NY (US); Elpida Tzortzatos, Lagrangeville, NY (US)

(21) Appl. No.: 14/749,991

(22) Filed: Jun. 25, 2015

(51) Int. Cl. G06F 17/30

(52) U.S. Cl. CPC G06F 17/30345

(57) ABSTRACT

Embodiments of the present invention provide methods, computer program products, and systems for performing bind breaks. Embodiments of the present invention can be used to reduce bind breaks by saving a save sequence number that reflects a count associated with updates made to a data structure responsive to performing an update to a data structure, retrieving a done sequence number that reflects a count associated with completed bind breaks, and determining whether the save sequence number is less than the done sequence number. Responsive to determining that the save sequence number is less than the done sequence number, embodiments of the invention can reuse the data structure without performing a bind break for the update of the data structure. Embodiments of the invention can be used to reduce bind breaks using sequence numbers to identify when a bind break occurred and updating other processors to avoid duplicating work.

### BACKGROUND OF THE INVENTION

The present invention relates generally to the field of management of computer memory resources, and more particular to synchronization of code using bind breaks.

Data coherency is threatened whenever two or more computer processes compete for a common data structure that is stored in a memory or when two or more copies of the same data file are stored in separate memories and one item is subsequently altered.

A bind break is a technique that Multiple Virtual Storage (MVS) systems use to synchronize code running on multiple processors (i.e., that a change to a data structure will be honored and any readers of the data structure have been completed). Typically, to accomplish that objective, a bind break flushes any currently running disabled code and purge the translation-lookaside buffer (TLB) and access register translation lookaside buffer (ALB).

### SUMMARY

Embodiments of the present invention provide methods, computer program products, and systems for performing bind breaks such that the number of bind breaks performed are reduced. In one embodiment of the present invention, a method is provided comprising: responsive to performing an update to a data structure of a plurality of data structures residing on shared memory, saving, a save sequence number, wherein the save sequence number reflects a count associated with updates made to the data structure; retrieving a done sequence number, wherein the done sequence number reflects a count associated with completed bind breaks; determining whether the save sequence number is less than the done sequence number; and responsive to determining that the save sequence number is not less than the done sequence number, performing a bind break for the update of the data structure, and incrementing a next sequence number, wherein the next sequence number reflects a count associated with updates made to the plurality of data structures.

### BRIEF DESCRIPTION OF THE DRAWINGS

FIG. 1 is a block diagram of a computing environment, in accordance with an embodiment of the present invention;

FIG. 2 is a flowchart illustrating operational steps for processing code, in accordance with an embodiment of the present invention;

FIG. 3 is a flowchart illustrating operational steps for reducing bind breaks during an update, in accordance with an embodiment; and

FIG. 4 is a block diagram of internal and external components of the computer systems of FIG. 1, in accordance with an embodiment of the present invention.

### DETAILED DESCRIPTION

Embodiments of the present invention recognize that performing bind breaks can be resource intensive. In instances where multiple processors that are part of a single system perform bind breaks, more resources are used and, as more processors are utilized, more disruption can be caused to the system. Embodiments of the present invention recognize that each bind break exacerbates the problem of limited resources further slowing performance. Embodiments of the present invention provide solutions for reducing bind breaks performed by processors using global sequence numbers. In this manner, as described in greater detail in the specification, embodiments of the present invention reduce bind breaks by identifying when a bind break occurred and updating other processors accordingly to avoid duplicating work.

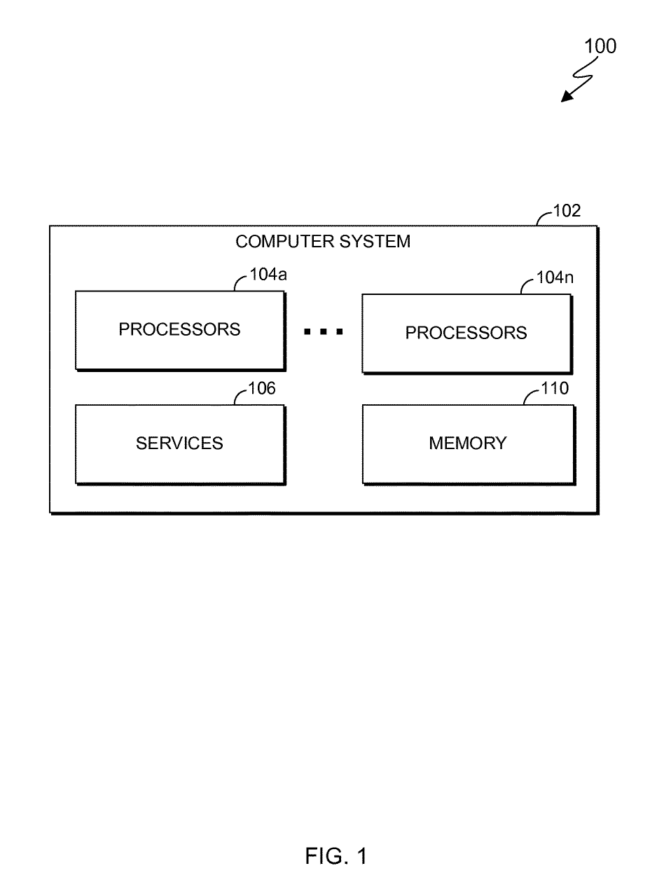

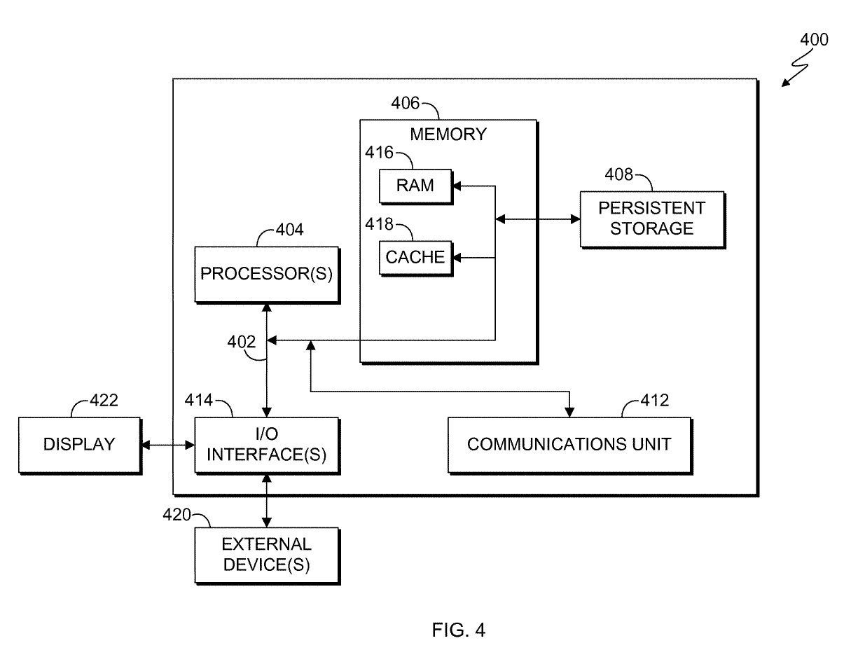

FIG. 1 is a functional block diagram of computing environment 100, in accordance with an embodiment of the present invention. Computing environment 100 includes computer system 102. Computer system 102 can be a desktop computer, laptop computer, specialized computer server, or any other computer system known in the art. In certain embodiments, computer system 102 represents a computer system utilizing clustered computers and components to act as a single pool of seamless resources when accessed through a network. For example, such embodiments may be used in data center, cloud computing, storage area network (SAN), and network attached storage (NAS) applications. In certain embodiments, computer system 102 represents a virtual machine. In general computer system 102 is representative of any electronic device, or combination of electronic devices, capable of executing machine-readable program instructions, as described in greater detail with regard to FIG. 4.

Computer system 102 includes processors 104a-n, services 106, and memory 110. Processors 104a-n access and manipulate data residing on respective, local (not shown) memory as well as data residing on memory 110 which is shared by processors 104a-n. For example, processors 104a-n can execute instructions (i.e. code) to update the data, identify that a bind break is needed, and initiate a bind break. Processors 104a-n can additionally signal other processors to participate in the bind break.

Processors 104a-n can indicate that a data structure has been manipulated by adding and deleting validity bits to data structure residing on memory 110. In this embodiment, validity bits correspond to data spaces (e.g., specialized address spaces in Multiple Virtual Storage (MVS) systems that contain only data (i.e., non-executable code). For example, processor 104a can delete a data space and update the validity bit to indicate that the data space is no longer valid.

In this embodiment, processors 104a-n can identify that a bind break needs to be performed, has occurred, or is occurring by reading global sequence numbers. The term, “global sequence numbers”, as used herein, refers to a naming and tracking convention that is used by processors 104a-n to track and identify bind breaks that result in multiple versions of the same data. In this embodiment, processors 104a-n use two sequence numbers to track when a bind break has occurred.

The first and second sequence numbers are the next and done sequence numbers, respectively. Both sequence numbers are shared and updated by each respective processor (e.g., processors 104a-n). The first sequence number is the next sequence number (also referred to as “next_seq#”). The term “next sequence number”, as used herein, reflects a count that indicates the most recent instance of a bind break that has started. The next sequence number is incremented when a processor (e.g., processor 104a) updates a data structure. For example, a processor such as processor 104a can increment the next sequence number by “1” for data structure X, which indicates that a bind break needs to be performed. Because the next sequence number is shared among processors 104a-n, the next sequence number can be updated by a different processor (e.g., 104b) working on a different structure (e.g., data structure Y). The second sequence number is the done sequence number (also referred to as “done_seq#”). The term, “done sequence number”, as used herein, reflects a count that indicates that the most recent instance of a bind break has been completed. Both sequence numbers have a starting value of zero.

The done sequence number is linked to the next sequence number (i.e., incremented by the same amount). For example, processors 104a-n increment the next sequence number by one, each time a bind break occurs. For example, when a first instance of a bind break occurs, the next sequence (e.g., next_seq#) is incremented from zero to one (e.g., from next_seq0 to next_seq1). Upon completion of the bind break, the processor (e.g., processor 104a) increments the done sequence number (e.g., done_seq#) is updated by “1” as well. Therefore, processors 104a-n can identify that no bind break is occurring when the next sequence number (e.g., next_seq#) equals the done sequence number (e.g., done_seq#). In contrast, processors 104a-n can identify that a bind break is currently started (i.e., in progress) when the next sequence number is greater than the done sequence number. Accordingly, processors 104a-n recognize that the data structures that correspond to the next and done sequence numbers cannot be reused or otherwise manipulated (i.e., I/O and other services are interrupted).

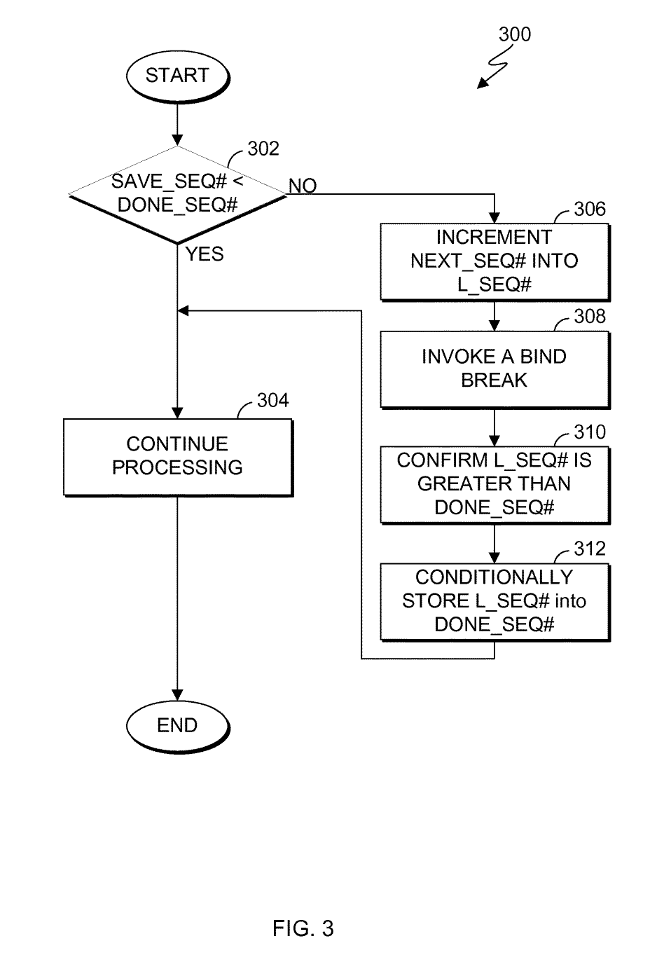

Processors 104a-n can track bind breaks by generating a save sequence number (also referred to as save_seq#). The term “save sequence number”, as used herein, reflects a count that is a copy of the next sequence number for each data structure. For example, each data structure being manipulated (e.g., UDD) can have its own save sequence number. In this embodiment, processors 104a-n generates a save sequence number by saving a copy of the next sequence number as a save sequence number (e.g., save_seq#) into storage (e.g., memory 110) associated with corresponding data structures (e.g., ASTE and UDD). Processors 104a-n can then track bind breaks by comparing the save sequence number (e.g., save_seq#) to the done sequence number (e.g., done_seq#) to determine whether a bind break needs to be performed, as discussed in greater detail with regard to FIG. 3. In this embodiment, processors 104a-n can identify that a bind break has occurred when the save sequence number is less than the done sequence number. Accordingly, the ASTE and UDD associated with the save sequence number can be reused. Conversely, processors 104a-n can identify that a bind break still needs to be performed when the save sequence number is not less than the done sequence number.

Services 106 are a collection of common code that other programs (e.g. processors 104a-n) can call. For example, services 106 can contain code for a bind break which can be accessed by processors 104a-n. Responsive to receiving an indication that a bind break should be performed, processors 104a-n performs a bind break using code accessed from services 106.

Memory 110 is shared storage media for processors 104a-n. In this embodiment, memory 110 is a dynamic random-access memory (DRAM). In this embodiment, memory 110 can store data spaces (i.e., specialized address spaces in Multiple Virtual Storage systems) which contain only data (i.e., non-executable code). In this embodiment, memory 110 includes a real storage manager (not shown) which represents data spaces using data control structures such as an Address Space Second Table Entry (ASTE) and User Data Space Descriptor (UDD). Each time a data space is created by a processor (e.g., processor 104a), a corresponding ASTE and UDD is assigned to that data space in memory 110. Each time a data space is deleted, a bind break must be performed before the ASTE and UDD can be reused.

Both ASTE and UDD can be accessed by processors (e.g., respective processors 104a-n) running disabled. The term “running disabled”, as used herein, refers to a processor (e.g., processor 104a) runs in a state where the processor cannot be interrupted. For example, processors 104a-n can locate these structures and determine whether the structure has changed by reading a validity bit in each ASTE and UDD before performing further processing. For example, responsive to determining that the validity bit in each ASTE and UDD is invalid, a single processor running disabled, (e.g., processor 104a) can inspect the save sequence number (save_seq#) to the respective UDD and ASTE to determine if a bind break is required before it can be reused.

It should be understood that, for illustrative purposes, FIG. 1 does not show other computer systems and elements which may be present when implementing embodiments of the present invention. For example, while FIG. 1 shows a single computer system 102, however, computing environment 100 can also include additional computer systems sharing a storage media.

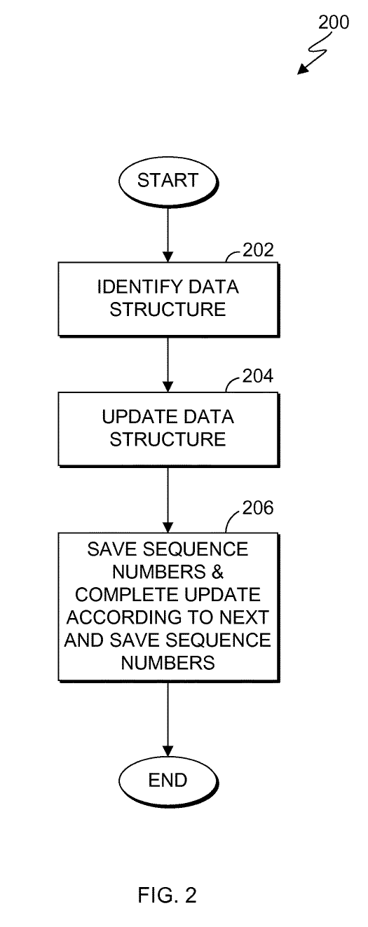

FIG. 2 is a flowchart 200 illustrating operational steps for processing code while running disabled, in accordance with an embodiment of the present invention. For illustrative purposes, the following discussion is made with respect to processor 104a performing and completing a single update which is visible across all processors 104a-n, it being understood that processors 104a-n can perform multiple updates, in parallel with other processors 104a-n, for any number of times until completion or some later time.

In step 202, processor 104a identifies data structure of data stored on memory 110. In this embodiment, processor 104a identifies the data structure by accessing and reading the data from memory 110. In other embodiments, processor 104a can identify data structure and reading data from one or more other components of computing environment 100 (e.g., other memory).

In step 204, processor 104a updates the data structure. In this embodiment, processor 104a accesses the data structure from memory 110 and updates the data structure by setting a single validity bit. For example, where processor 104a is updating the data structure, processor 104a can change the validity bit to indicate that these bits are no longer valid. Accordingly, processors 104a-n stop running processes on that data structure.

In step 206, processor 104a saves a current next sequence number associated with the update to the data structure and completes the update to the data structure. In this embodiment, a processor (e.g., processor 104a) saves a copy of the global next_seq# into the save_seq# to memory 110 associated with the data structure (e.g., save_seq# is saved into the invalidated UDD and ASTE). In this embodiment, the saved copy of the global next sequence (e.g., save_seq#) number indicates when the UDD and ASTE were invalidated and whether a bind break has to be invoked before any processors (e.g., processors 104b-n) can delete or reuse the UDD and ASTE. In other words, the saved copy of the global next sequence number (i.e., the save_seq# in the UDD and ASTE) can later be used to determine if a bind break has occurred since the data structure has updated.

Accordingly, in this embodiment, a single processor can update the data structure and indicate to other processors when the data structure was changed by saving a copy of the global next sequence number as a save sequence number. The other processors can then, as detailed in FIG. 3, determine if a bind break has occurred since the update and continue processing to either reuse or delete respective UDD and ASTE.

FIG. 3 is a flowchart 300 illustrating operational steps for reducing bind breaks after an update, in accordance with an embodiment. For example, the operational steps of flowchart 300 can be performed after step 206 of flowchart 200. For illustrative purposes, the following discussion is made with respect to processor 104a performing and completing a single update across all processors 104a-n, it being understood processors 104a-n can perform multiple updates, in parallel, for any number of times until completion or some later time.

In step 302, processors 104a-n determines whether the save sequence is less than the done sequence. In this embodiment, processors 104a-n determines whether the save sequence is less than the done sequence (i.e., done_seq#) by comparing the respective sequence numbers. In this embodiment, where a numerical scale is used, where lower numbers indicate lesser values than higher numbers (e.g., one is less than 2). Thus, a save sequence is less than the done sequence if the save sequence number has a lesser number than done sequence number (e.g., a save sequence number of 1, while a done sequence of 2).

If, in step 302, processor 104a determines that the save sequence is less than the done sequence, then, in step 304, processor 104a continues processing because a bind break has already occurred. In this embodiment, processor 104a continues processing by reusing the ASTE and UDD.

If, in step 302, processor 104a determines that the save sequence is not less than the done sequence number, then, in step 306, processor 104a increments the next sequence number into local storage (i.e., a local sequence number). The term, “local sequence number” (also referred to as “l_seq#”), as used herein, reflects a count associated with bind break processing and is a count that is specific to an instance of a bind break. For example if there are two bind breaks occurring at the same time (across the same processors), there would be two separate local sequence numbers.

In this embodiment, processor 104a increments the next sequence number and saves the incremented value into local storage (e.g., l_seq#). For example, processor 104a determines that the next sequence number is two (e.g., next_seq2) and then increments the next sequence number by one so that the resulting next sequence number is next_seq3. Processor 104a then saves that resulting next sequence number into local storage resulting in l_seq3.

In step 308, processor 104a invokes a bind break service (e.g., processors 104b-n) to perform a bind break (i.e., to flush all processors 104b-n which might be using the UDD and ASTE assuming it is still valid). In this embodiment, processor 104a calls services 106, performs the bind break, which signals the other processors to participate in the bind break. Accordingly, the other processors (e.g., processors 104b-n) receive the signal and finish processing. Processors 104b-n, responsive to receiving the signal to perform the bind break, perform the bind break by purging their respective translation-lookaside buffer (TLB) and access register translation lookaside buffer (ALB) and signal processor 104a when complete.

In step 310, processor 104a confirms that the local sequence number is greater than the done sequence number. Continuing the above example, processor 104a can confirm that the local sequence number is greater than the done sequence number by reading the sequence numbers. In this embodiment, processor 104a confirms that the local sequence number, that is, the updated next sequence number (e.g., l_seq3), is greater than the done sequence number (e.g., done_seq2) by comparing the respective sequence numbers. In instances where local sequence number is equal to or less than the done sequence number, processor 104a does not save the local sequence number as the done sequence number. In instances where local sequence number is equal to or less than the done sequence number, processor 104a does not save the local sequence number as the done sequence number.

In step 312, processor 104a conditionally stores the local sequence number into done sequence number. In this embodiment, processor 104a stores the local sequence number into the done sequence number when the local sequence number is greater than the done sequence number by executing a compare and swap instruction to save the local sequence number as the done sequence number. Continuing the example above, processor 104a executes an instruction to save the local sequence number (e.g., l_seq3) as the done sequence number which results in the done sequence number being updated to done_seq3. Accordingly, the done sequence number now reflects the completed bind break and subsequent update (e.g., done_seq3). Processors 104a-n can then continue processing (i.e., reusing the ASTE and UDD associated with save_seq2) as previously discussed with regard to step 306. Where the local sequence number is equal to or less than the done sequence number, processor 104a does not save the local sequence number as the done sequence number.

In instances where multiple processors update the same data structure (e.g., a UDD), only the highest local sequence number, that is, the local sequence number that reflects the most recent bind break is stored into the done sequence number. For example, processor 104a can identify that the save sequence number (e.g., save_seq2) of a data structure (e.g., UDD1) is not less than the done sequence number (e.g., done_seq2). Processor 104a then increments the next sequence number by one so that the resulting next sequence number is next_seq3. Processor 104a can then save that resulting next sequence number into local storage resulting in l_seq3. Accordingly a bind break is performed.

Prior to the completion of the bind break, processor 104b accesses and reuses a different UDD (e.g., UDD2) that has a save sequence of 3 (e.g., save_seq3). Processor 104b can then identity that the done sequence is 2 (e.g., done_seq2) and increment the next sequence number by 1 resulting in next_seq4 and execute the compare and swap instruction to the local storage to set the next sequence number to the local sequence number resulting in l_seq4. Accordingly, in this example another bind break is performed but finished before processor 104a.

In this example, processor 104b stores its local sequence number (e.g., l_seq4) as the done sequence number (e.g., done_seq4) obviating the need for processor 104a to store its l_seq3 (because its local sequence number is less than the done sequence number, as in step 310).

FIG. 4 is a block diagram of internal and external components of a computer system 400, which is representative of the computer system of FIG. 1, in accordance with an embodiment of the present invention. It should be appreciated that FIG. 4 provides only an illustration of one implementation and does not imply any limitations with regard to the environments in which different embodiments may be implemented. In general, the components illustrated in FIG. 4 are representative of any electronic device capable of executing machine-readable program instructions. Examples of computer systems, environments, and/or configurations that may be represented by the components illustrated in FIG. 4 include, but are not limited to, personal computer systems, server computer systems, thin clients, thick clients, laptop computer systems, tablet computer systems, cellular telephones (e.g., smart phones), multiprocessor systems, microprocessor-based systems, network PCs, minicomputer systems, mainframe computer systems, and distributed cloud computing environments that include any of the above systems or devices.

Computer system 400 includes communications fabric 402, which provides for communications between one or more processors 404, memory 406, persistent storage 408, communications unit 412, and one or more input/output (I/O) interfaces 414. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 416 and cache memory 418. In general, memory 406 can include any suitable volatile or non-volatile computer-readable storage media. Software is stored in persistent storage 408 for execution and/or access by one or more of the respective processors 404 via one or more memories of memory 406.

Persistent storage 408 may include, for example, a plurality of magnetic hard disk drives. Alternatively, or in addition to magnetic hard disk drives, persistent storage 808 can include one or more solid state hard drives, semiconductor storage devices, read-only memories (ROM), erasable programmable read-only memories (EPROM), flash memories, or any other computer-readable storage media that is capable of storing program instructions or digital information.

The media used by persistent storage 408 can also be removable. For example, a removable hard drive can be used for persistent storage 408. Other examples include optical and magnetic disks, thumb drives, and smart cards that are inserted into a drive for transfer onto another computer-readable storage medium that is also part of persistent storage 408.

Communications unit 412 provides for communications with other computer systems or devices via a network. In this exemplary embodiment, communications unit 412 includes network adapters or interfaces such as a TCP/IP adapter cards, wireless Wi-Fi interface cards, or 3G or 4G wireless interface cards or other wired or wireless communication links. The network can comprise, for example, copper wires, optical fibers, wireless transmission, routers, firewalls, switches, gateway computers and/or edge servers. Software and data used to practice embodiments of the present invention can be downloaded to computer system 102 through communications unit 412 (e.g., via the Internet, a local area network or other wide area network). From communications unit 412, the software and data can be loaded onto persistent storage 408.

One or more I/O interfaces 414 allow for input and output of data with other devices that may be connected to computer system 400. For example, I/O interface 414 can provide a connection to one or more external devices 420 such as a keyboard, computer mouse, touch screen, virtual keyboard, touch pad, pointing device, or other human interface devices. External devices 420 can also include portable computer-readable storage media such as, for example, thumb drives, portable optical or magnetic disks, and memory cards. I/O interface 414 also connects to display 422.

Display 422 provides a mechanism to display data to a user and can be, for example, a computer monitor. Display 422 can also be an incorporated display and may function as a touch screen, such as a built-in display of a tablet computer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for performing bind breaks, the method comprising:
responsive to performing an update to a data structure of a plurality of data structures residing on shared memory, saving, by one or more computer processors, a save sequence number, wherein the save sequence number reflects a count associated with updates made to the data structure;
retrieving, by one or more computer processors, a done sequence number, wherein the done sequence number reflects a count associated with completed bind breaks;
determining, by one or more computer processors, whether the save sequence number is less than the done sequence number; and
responsive to determining that the save sequence number is not less than the done sequence number, performing, by one or more computer processors, a bind break for the update of the data structure, and incrementing a next sequence number, wherein the next sequence number reflects a count associated with updates made to the plurality of data structures.

2. The method of claim 1, further comprising:
responsive to determining that the save sequence number is not less than the done sequence number, saving, by one or more computer processors, the next sequence number into a local sequence number, wherein the local sequence number reflects a count associated with the bind break; and
responsive to confirming that the local sequence number is greater than the done sequence number, storing, by one or more computer processors, the local sequence number as the done sequence number.

3. The method of claim 1, wherein performing an update to a data structure of a plurality of data structures residing on shared memory comprises:
manipulating, by one or more computer processors, validity bits that correspond to the data structure of the plurality of data structures.

4. The method of claim 1, wherein the data structure of the plurality of data structures is an Address Space Second Table Entry (ASTE) or a User Data Space Descriptor (UDD).

5. The method of claim 1, wherein the next sequence number is incremented by a plurality of computer processors to reflect a count associated with updates made to the plurality of data structures by each of the plurality of computer processors.

6. The method of claim 1, wherein each data structure of the plurality of data structures is associated with a separate save sequence number that reflects a count associated with updates made to each respective data structure of the plurality of data structures.

7. The method of claim 1, further comprising:
responsive to determining that the save sequence number is less than the done sequence number, reusing the data structure of the plurality of data structures without performing a bind break for the update of the data structure.

8. A computer program product for performing bind breaks, the computer program product comprising:
one or more computer readable storage media and program instructions stored on the one or more computer readable storage media, the program instructions comprising:
program instructions to, responsive to performing an update to a data structure of a plurality of data structures residing on shared memory, save a save sequence number, wherein the save sequence number reflects a count associated with updates made to the data structure;
program instructions to retrieve a done sequence number, wherein the done sequence number reflects a count associated with completed bind breaks;
program instructions to determine whether the save sequence number is less than the done sequence number; and
program instructions to, responsive to determining that the save sequence number is not less than the done sequence number, perform a bind break for the update of the data structure, and incrementing a next sequence number, wherein the next sequence number reflects a count associated with updates made to the plurality of data structures.

9. The computer program product of claim 8, wherein the program instructions stored on the one or more computer readable storage media further comprise:
program instructions to, responsive to determining that the save sequence number is not less than the done sequence number, save the next sequence number into a local sequence number, wherein the local sequence number reflects a count associated with the bind break; and
program instructions to, responsive to confirming that the local sequence number is greater than the done sequence number, store the local sequence number as the done sequence number.

10. The computer program product of claim 8, wherein the program instructions to perform an update to a data structure of a plurality of data structures residing on shared memory comprise:
program instructions to manipulate validity bits that correspond to the data structure of the plurality of data structures.

11. The computer program product of claim 8, wherein the data structure of the plurality of data structures is an Address Space Second Table Entry (ASTE) or a User Data Space Descriptor (UDD).

12. The computer program product of claim 8, wherein the next sequence number is incremented by a plurality of computer processors to reflect a count associated with updates made to the plurality of data structures by each of the plurality of computer processors.

13. The computer program product of claim 8, wherein each data structure of the plurality of data structures is associated with a separate save sequence number that reflects a count associated with updates made to each respective data structure of the plurality of data structures.

14. The computer program product of claim 8, wherein the program instructions stored on the one or more computer readable storage media further comprise:
program instructions to responsive to determining that the save sequence number is less than the done sequence number, reuse the data structure of the plurality of data structures without performing a bind break for the update of the data structure.

15. A computer system for performing bind breaks, the computer system comprising:
one or more computer processors;
one or more computer-readable storage media;
program instructions stored on the computer-readable storage media for execution by at least one of the one or more processors, the program instructions comprising:
program instructions to, responsive to performing an update to a data structure of a plurality of data structures residing on shared memory, save a save sequence number, wherein the save sequence number reflects a count associated with updates made to the data structure;
program instructions to retrieve a done sequence number, wherein the done sequence number reflects a count associated with completed bind breaks;
program instructions to determine whether the save sequence number is less than the done sequence number; and
program instructions to, responsive to determining that the save sequence number is not less than the done sequence number, perform a bind break for the update of the data structure, and incrementing a next sequence number, wherein the next sequence number reflects a count associated with updates made to the plurality of data structures.

16. The computer system of claim 15, wherein the program instructions stored on the one or more computer readable storage media further comprise:
program instructions to, responsive to determining that the save sequence number is not less than the done sequence number, save the next sequence number into a local sequence number, wherein the local sequence number reflects a count associated with the bind break; and
program instructions to, responsive to confirming that the local sequence number is greater than the done sequence number, store the local sequence number as the done sequence number.

17. The computer system of claim 15, wherein the program instructions to perform an update to a data structure of a plurality of data structures residing on shared memory comprise:
program instructions to manipulate validity bits that correspond to the data structure of the plurality of data structures.

18. The computer system of claim 15, wherein the data structure of the plurality of data structures is an Address Space Second Table Entry (ASTE) or a User Data Space Descriptor (UDD).

19. The computer system of claim 15, wherein the next sequence number is incremented by a plurality of computer processors to reflect a count associated with updates made to the plurality of data structures by each of the plurality of computer processors.

20. The computer system of claim 15, wherein each data structure of the plurality of data structures is associated with a separate save sequence number that reflects a count associated with updates made to each respective data structure of the plurality of data structures.
